(19) United States
(12) Patent Application Publication
(10) Pub. No.: US 2026/0367485 A1
(43) Pub. Date: Nov. 19, 2026

(54) LINEAR DRIVE DEVICE THAT IS LOW IN GUIDE RESISTANCE, LENS BARREL, AND IMAGE CAPTURING SYSTEM

(71) Applicant: CANON KABUSHIKI KAISHA, Tokyo (JP)

(72) Inventor: TAKUTO ICHIHARA, Tokyo (JP)

(21) Appl. No.: 19/660,568

(22) Filed: Apr. 28, 2026

(30) Foreign Application Priority Data
May 13, 2025 (JP) 2025-080414

(51) Int. Cl. G03B 13/36; G03B 5/02

(52) U.S. Cl. CPC G03B 13/36; G03B 5/02; G03B 2205/0046

(57) ABSTRACT

A linear drive device includes a linear actuator arranged inside a fixed barrel, for driving a driven body in a first direction, a cover member attached to the fixed barrel having a side opening, and a linear guide including a main guide bar and a sub guide bar for movably supporting the driven body. The linear actuator includes a field part having hollow permanent magnets, a coil part fixed to the cover member in the side opening and formed by coils surrounding an outer periphery of the field part, and a pipe-shaped holding member inserted in a hole of the field part and fixed to the driven body. The main guide bar is inserted through a hole of the pipe-shaped holding member, and fixing portions for holding the pipe-shaped holding member on the driven body are formed in an opening which opens toward the side opening.

### BACKGROUND

### Field of the Technology

The present disclosure relates to a linear drive device that is low in guide resistance, a lens barrel equipped with the linear drive device, and an image capturing system.

### DESCRIPTION OF THE RELATED ART

A linear drive device has been widely put to practical use for a positioning mechanism of a precision apparatus, a conveying apparatus, a transportation apparatus, or the like. As the linear drive device, there has been conventionally proposed one using an electromagnetic linear DC motor or a friction-type linear ultrasonic motor, and further, there is known one that converts a rotational drive force generated by driving a rotary motor to a linear driving force by using a linear motion-converting mechanism, such as a rack and pinion mechanism.

For example, Japanese Laid-Open Patent Publication (Kokai) No. 2023-129928 and Japanese Laid-Open Patent Publication (Kokai) No. 2007-129824 each disclose a linear drive device that moves a lens forward and backward in an optical axis direction inside a lens barrel. Specifically, Japanese Laid-Open Patent Publication (Kokai) No. 2023-129928 discloses a configuration in which a plurality of linear actuators are arranged along an outer periphery of the lens in a case where the center of gravity of a driven body is within the lens. Further, Japanese Laid-Open Patent Publication (Kokai) No. 2007-129824 discloses a configuration in which a single linear actuator is arranged coaxially with a guide bar and at the same time is connected to an engagement portion, which is engaged with the guide bar, of a lens holder.

According to the technique disclosed in Japanese Laid-Open Patent Publication (Kokai) No. 2023-129928, it is possible to make an action axis of thrust as the resultant force of the plurality of linear actuators close to the center of gravity of the driven body. Further, according to the technique disclosed in Japanese Laid-Open Patent Publication (Kokai) No. 2007-129824, it is possible to cause an action axis of thrust of the linear actuator to substantially coincide with the guide bar. As a result, according to the techniques disclosed in Japanese Laid-Open Patent Publication (Kokai) No. 2023-129928 and Japanese Laid-Open Patent Publication (Kokai) No. 2007-129824, it is possible to reduce the guide resistance.

The technique disclosed in Japanese Laid-Open Patent Publication (Kokai) No. 2023-129928 has a problem that the number of components is increased, and a problem that the size of the lens barrel as the product is increased, and further, the weight of the same is liable to be increased. Further, the technique disclosed in Japanese Laid-Open Patent Publication (Kokai) No. 2007-129824 has a problem that the engagement portion, which is engaged with the guide bar, of the lens holder and the linear actuator are arranged side by side in the optical axis direction as the linear driving direction, and hence the size of the lens barrel is liable to be increased in the linear driving direction.

### SUMMARY

The present disclosure is directed to providing a linear drive device that is low in guide resistance and prevents a product including the linear drive device from being increased in size and weight.

The present disclosure provides a linear drive device including a fixed barrel having a side opening, a cover member that is attached to the fixed barrel in the side opening, a driven body that has an object to be driven and is accommodated inside the fixed barrel, a linear actuator that is arranged inside the fixed barrel and drives the driven body in a first direction, and a linear guide that includes a main guide bar and a sub guide bar for supporting the driven body in a state movable in the first direction inside the fixed barrel, wherein the linear actuator includes a field part having hollow-shaped permanent magnets, a coil part that is fixed to the cover member and is formed by hollow-shaped coils arranged to surround an outer periphery of the field part, and a pipe-shaped holding member that is inserted in a hole of the field part to hold the field part and is fixed to the driven body, wherein the main guide bar is inserted through a hole of the pipe-shaped holding member, and wherein fixing portions for fixing the pipe-shaped holding member are formed in an opening which opens toward the side opening.

Features of the present disclosure will become apparent from the following description of embodiments with reference to the attached drawings. The following description of embodiments are described by way of example.

### BRIEF DESCRIPTION OF THE DRAWINGS

FIG. 1 is a view showing a schematic configuration of an image capturing system according to an embodiment of the present disclosure.

FIG. 2 is an exploded perspective view showing a schematic configuration of a linear drive device according to a first embodiment.

FIG. 3 is a perspective view showing a configuration of essential parts of the linear drive device according to the first embodiment.

FIGS. 4A and 4B are an appearance perspective view of the linear drive device according to the first embodiment and a perspective view showing a structure of a linear actuator, part of which is illustrated in cross section.

FIGS. 5A and 5B are views useful in explaining a structure of an actuator accommodating part included in a lens holder of the linear drive device according to the first embodiment.

FIG. 6 is a perspective view showing a configuration of essential parts of a linear drive device according to a comparative example.

FIGS. 7A to 7D are views useful in explaining forces acting on a lens assembly when driving the linear drive devices according to the first embodiment and the comparative example.

FIGS. 8A to 8C are schematic views showing how to assemble the linear drive device according to the first embodiment.

FIG. 9 is an exploded perspective view showing a configuration of a linear drive device according to a second embodiment.

### DESCRIPTION OF THE EMBODIMENTS

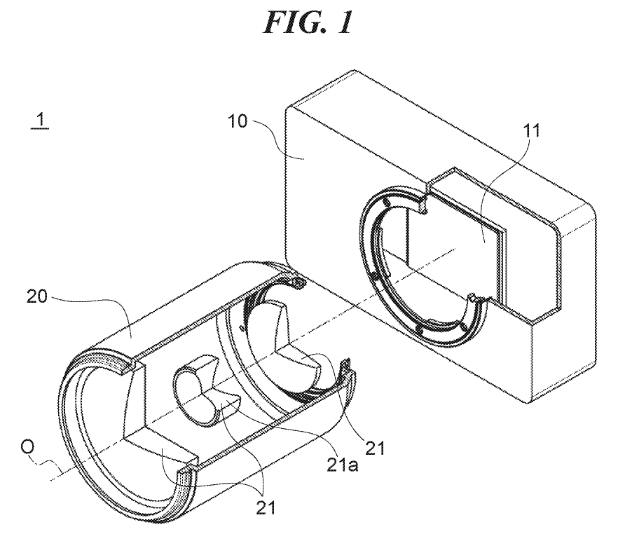

The present disclosure will now be described in detail below with reference to the accompanying drawings showing embodiments thereof. FIG. 1 is a view showing a schematic configuration of an image capturing system 1 according to a first embodiment. The image capturing system 1 is formed by an image capturing apparatus 10 and a lens barrel 20 which can be removably attached to the image capturing apparatus 10. Note that the image capturing apparatus 10 and the lens barrel 20 can be integrally configured, i.e., can be configured such that the lens barrel 20 cannot be removably attached, and in this case, “the image capturing apparatus” is referred to as “the image capturing apparatus body”, and “the image capturing system” is referred to as “the image capturing apparatus”.

The image capturing apparatus 10 is a so-called lens-interchangeable-type digital camera and includes an image sensor 11, such as a CMOS sensor. The lens barrel 20 is one generally referred to as the interchangeable lens and includes a lens group 21. The lens barrel 20 has a mount portion having a known structure, such as a bayonet engagement structure, and is configured to be removably attachable to the image capturing apparatus 10 such that a photographing optical axis O of the lens group 21 passes through the center of an imaging surface of the image sensor 11. Incident light passing through the inside of the lens barrel 20 forms an optical image on the imaging surface of the image sensor 11, and the image sensor 11 converts the optical image to electrical signals (image signals). Note that the image capturing apparatus 10 can be a conventional apparatus using a known technique, and detailed description of the configuration of the image capturing apparatus 10 is omitted.

The lens barrel 20 is configured to be capable of executing focusing for bringing an object into focus by driving a linear actuator to advance and retreat (move forward and backward) a focus lens 21a as one of the lenses forming the lens group 21 in an optical axis direction. The lens barrel 20 is configured to be capable of executing zooming for adjusting an angle of view by driving a linear actuator to advance and retreat a zoom lens as one of the lenses forming the lens group 21 in the optical axis direction. Note that the optical axis direction refers to a direction in which the photographing optical axis O extends.

A lens drive device for performing focusing and a lens drive device for performing zooming can have the same configuration. Hereafter, the lens drive device for performing focusing will be described.

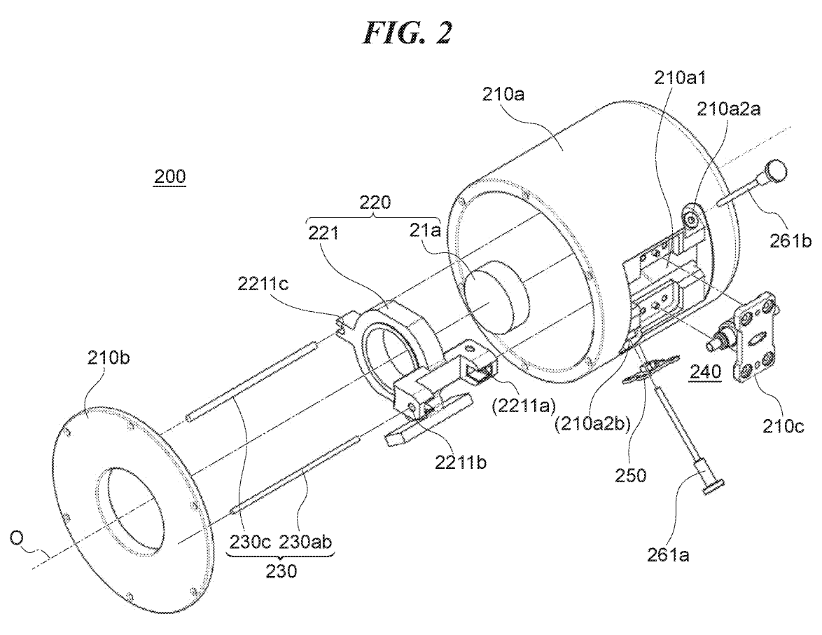

FIG. 2 is an exploded perspective view showing a schematic configuration of a linear drive device 200 arranged within the lens barrel 20, as the lens drive device for performing focusing. The linear drive device 200 includes the focus lens 21a, a lens holder 221, a rear base member 210a, a front base member 210b, and a side base member 210c. Further, the linear drive device 200 includes a main guide bar 230ab, a sub guide bar 230c, a linear actuator 240, and a linear encoder 250. Note that temporary fixing pins 261a and 261b, appearing in FIG. 2, are jigs used when the linear drive device 200 is assembled, and a process for assembling the linear drive device 200 will be described hereinafter.

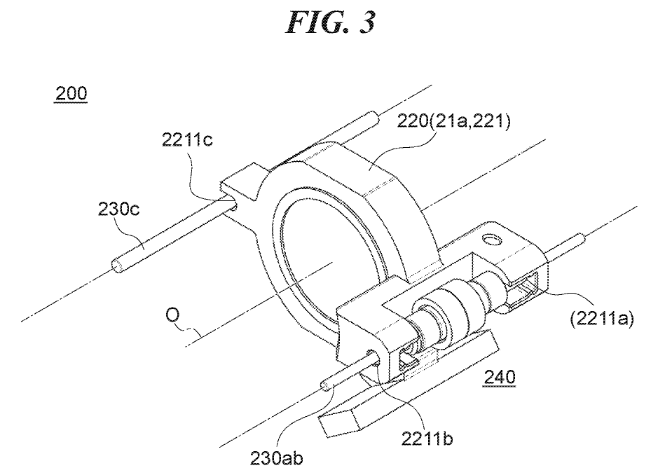

The rear base member 210a and the front base member 210b form a base body (so-called fixed barrel) of the linear drive device 200. The side base member 210c is fixed to the rear base member 210a in a state holding coils 241a and 241b (see FIG. 3) forming a fixed part of the linear actuator 240. The rear base member 210a is formed with a side opening 210a1 for inserting the side base member 210c holding the linear actuator 240 from a direction (radial direction) perpendicular to the optical axis direction. The “side base member 210c holding the linear actuator 240” mentioned here refers to the side base member 210c in a state in which a movable part (described hereinafter in detail) of the linear actuator 240 is inserted through the coils 241a and 241b fixed to the side base member 210c. The side base member 210c is a coil holding member for holding the coils 241a and 241b and at the same time is a cover member for covering part of the side opening 210a1 in the state holding the coils 241a and 241b.

The periphery of the side opening 210a1 is formed such that the side base member 210c can be fixed e.g. with screws. A side surface of the rear base member 210a is provided with temporary fixing holes 210a2a and 210a2b. The temporary fixing holes 210a2a and 210a2b are inserted portions for inserting the temporary fixing pins 261a and 261b for temporarily fixing the lens holder 221 to which the focus lens 21a has been fixed, to the rear base member 210a when the linear drive device 200 is assembled. Note that in FIG. 2, an approximate position of the temporary fixing hole 210a2b is indicated.

The lens holder 221 is a holding member for holding the focus lens 21a, and the focus lens 21a is fixed to the lens holder 221 by bonding, caulking, or a like method. Note that the photographing optical axis O is also a virtual line passing through the center of the focus lens 21a.

In the following description, the lens holder 221 to which the focus lens 21a is fixed is referred to as the “lens assembly 220”. The focus lens 21a is defined as an object to be driven by the linear drive device 200, and the lens assembly 220 is defined as a driven body for the linear drive device 200.

The main guide bar 230ab and the sub guide bar 230c are arranged on respective opposite sides of the lens holder 221 with a fixed distance therebetween such that directions of the lengths thereof are substantially parallel to the photographing optical axis O, thereby forming a linear guide 230. The opposite ends of the main guide bar 230ab and the sub guide bar 230c in the length direction are fixed to the rear base member 210a and the front base member 210b, respectively.

The lens holder 221 is formed with main engagement portions 2211a and 2211b which are slidably engaged with the main guide bar 230ab, and a sub engagement portion 2211c which is slidably engaged with the sub guide bar 230c. Note that in FIG. 2, as to the main engagement portion 2211a, an approximate location thereof is indicated. Since the main engagement portions 2211a and 2211b are engaged with the main guide bar 230ab, and at the same time, the sub engagement portion 2211c is engaged with the sub guide bar 230c, the lens assembly 220 is supported by the linear guide 230 in a state movable in the optical axis direction. That is, the lens assembly 220 is movably supported by the linear guide 230, in the linear driving direction (first direction) set to the optical axis direction.

The linear actuator 240 is an electromagnetic linear DC motor. The linear actuator 240 will be described in detail hereinafter but will be simply described here. The linear actuator 240 roughly has a structure in which a hollow cylindrical-shaped field part including permanent magnets and a hollow cylindrical-shaped coil part including the coils are coaxially arranged. Further, the linear actuator 240 is configured such that an axis of action when extracting, as the thrust, the Lorentz force generated by energizing the coil part is substantially parallel to the linear driving direction

Note that the shape of the permanent magnet is not limited to the hollow cylindrical shape insofar as it is hollow-shaped, and for example, the permanent magnet can be formed into a shape formed with a circular through hole in the center of a rectangular parallelepiped magnet. In this case, it is necessary to change the shapes of part of the other components, such as the coil, in accordance with the shape of the permanent magnet.

In the following description, the field part and the coil part of the linear actuator 240 are referred to as the “field part FM” and the “coil part CP”, respectively. Note that as will be described hereinafter with reference to FIGS. 3A and 3B, the field part FM is formed by permanent magnets 242a, 242b, and 242c, and yokes 243a and 243b, and the coil part CP is formed by the coils 241a and 241b.

The coil part CP and the field part FM are coaxially arranged, with a fixed spacing between an inner peripheral surface of the coil part CP and an outer peripheral surface of the field part FM. The coil part CP is fixed to the side base member 210c e.g. with a UV adhesive, and is positioned and fixed by fixing the side base member 210c to the rear base member 210a e.g. with screws. In a hole of the field part FM having the hollow cylindrical shape, a field part-fixing pipe 246, described hereinafter, as a pipe-shaped holding member for holding the field part FM is inserted, and the field part FM is fixed to the field part-fixing pipe 246. The main guide bar 230ab is inserted through the hole of the field part-fixing pipe 246 such that a fixed spacing is formed between an inner peripheral surface of the field part-fixing pipe 246 and an outer peripheral surface of the main guide bar 230ab, and at the same time the field part-fixing pipe 246 and the main guide bar 230ab are coaxial with each other.

The linear encoder 250 is attached to the rear base member 210a and detects a position of the lens assembly 220 in the optical axis direction with respect to the rear base member 210a and the front base member 210b. A known technique can be used for wiring for driving the linear actuator 240, i.e. wiring of e.g. power feeder to the coil part CP, and configuration and arrangement of a driving circuit, and hence illustration and description thereof is omitted.

FIG. 3 is a perspective view showing the arrangement of essential parts of the linear drive device 200, in which the lens assembly 220, the main guide bar 230ab, the sub guide bar 230c, and the linear actuator 240 are illustrated.

The main engagement portions 2211a and 2211b of the lens holder 221 each are formed into a substantially hollow cylindrical shape at respective locations spaced from each other by a fixed distance (main guide baseline length) in the optical axis direction, which is the linear driving direction, and are slidably engaged with (fitted on) the main guide bar 230ab. That is, the main guide bar 230ab is in a state inserted through the holes of the main engagement portions 2211a and 2211b in the linear driving direction. With this arrangement, it is possible to regulate movement of the lens assembly 220 in total four directions of translational movement expressed by components of two directions which are orthogonal to each other within a plane perpendicular to the linear driving direction, and pitching and yawing movements with respect to the linear driving direction.

The sub engagement portion 2211c has a groove shape having a certain length in the linear driving direction and is slidably engaged with (fitted on) the sub guide bar 230c. A direction in which two side walls forming the groove shape of the sub engagement portion 2211c are opposed to each other (direction perpendicular to the side wall surfaces) is substantially orthogonal to a plane including the central axis of the main guide bar 230ab and the central axis of the sub guide bar 230c. With this, it is possible to prevent rotation (roll) of the lens assembly 220 about the main guide bar 230ab.

Therefore, the lens assembly 220 is regulated from moving in total five directions except the linear driving direction, by a combination of the main guide bar 230ab and the main engagement portions 2211a and 2211b, and a combination of the sub guide bar 230c and the sub engagement portion 2211c. Further, the directions regulated by the respective combinations do not overlap, and hence it is possible to reduce an influence applied by shapes and an arrangement error of the components on variation of performance as much as possible.

The linear actuator 240 is arranged between the two main engagement portions 2211a and 2211b. As described above, the main engagement portions 2211a and 2211b are required to be formed to have a fixed main guide baseline length, but a space area between the main engagement portions 2211a and 2211b has not been conventionally used. In the linear drive device 200, by arranging the linear actuator 240 in the space area formed between the main engagement portions 2211a and 2211b, it is possible to prevent the product (the lens barrel 20 in the present embodiment) from being increased in size.

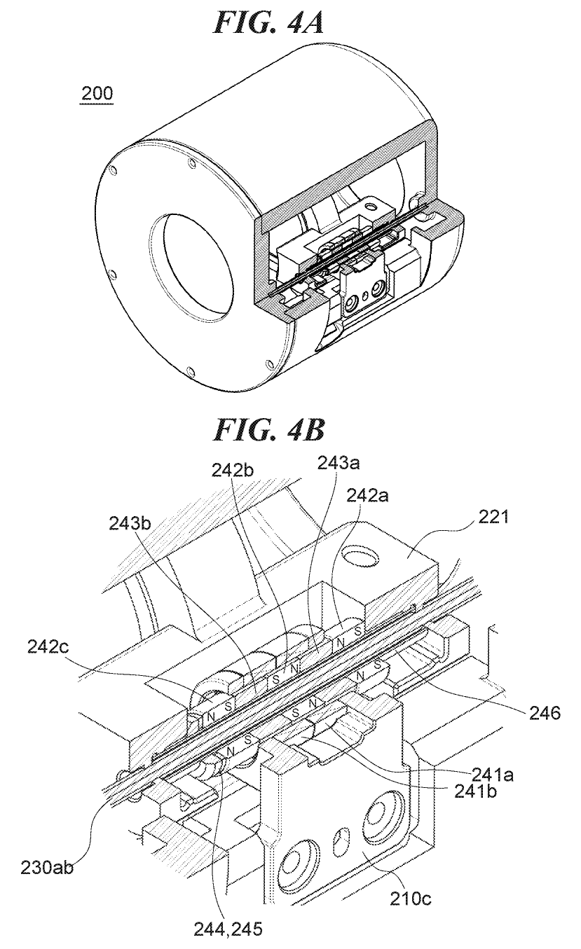

Next, the configuration of the linear actuator 240 will be described in detail. FIG. 4A is an appearance perspective view of the linear drive device 200, in which part thereof is cut off and illustrated in cross section. The cross sections appearing in FIG. 4A are a cross section cut along a plane including the photographing optical axis O (not shown) and the central axis of the main guide bar 230ab, and a cross section cut along a plane which is orthogonal to this plane and at the same time includes the central axis of the main guide bar 230ab. FIG. 4B is a partially enlarged view of FIG. 4A.

The linear actuator 240 has the hollow cylindrical-shaped coils 241a and 241b (the coil part CP). Further, the linear actuator 240 includes the hollow cylindrical-shaped permanent magnets 242a to 242c and the yokes 243a and 243b (the field part FM), a filling member 244 and a cushioning member 245 for biasing and positioning these, and the field part-fixing pipe 246. These components are all arranged substantially coaxially with the main guide bar 230ab.

The number of the permanent magnets and the yokes is not limited to the above-mentioned number. The permanent magnets 242a to 242c, the yokes 243a and 243b, the filling member 244, the cushioning member 245, and the field part-fixing pipe 246 form the movable part of the linear actuator 240, with respect to the coils 241a and 241b forming the fixed part of the linear actuator 240. Note that although in the present embodiment, the field part-fixing pipe 246 will be described as a component of the linear actuator 240, the field part-fixing pipe 246 can be treated as a separate component of the lens holder 221.

The linear actuator 240 has a structure (so-called in-coil magnet arranging type structure), in which the field part FM is positioned inside the coil part CP and at the same time extends in the linear driving direction, on an optical axis projection plane, and is characterized in compactness and lightweight. Further, although details will be described hereinafter, in the linear actuator 240, the central axis of the coil part CP as a thrust application point, and the central axis of the main guide bar 230ab substantially coincide with each other, on an optical axis projection plane, and hence it is possible to reduce the guide resistance. Note that the optical axis projection plane refers to a virtual plane orthogonal to the photographing optical axis O, and the phrase “substantially coincide on an optical axis projection plane” is intended to mean “substantially overlap when viewed from a direction in which the photographing optical axis O extends”.

A fixed spacing is formed between the inner peripheral surfaces of the coils 241a and 241b and the outer peripheral surface of the field part FM. The coils 241a and 241b are fixed to the side base member 210c e.g. by UV adhesion and fixed to the rear base member 210a e.g. with screws, whereby the coils 241a and 241b each are arranged at a predetermined location in the linear drive device 200. Note that the side base member 210c is formed with part for adhesively holding the coils 241a and 241b at two locations so as to sandwich the coils 241a and 241b in the linear driving direction. However, this is not limitative, but this part can be arranged at one location.

Opposite ends of the field part-fixing pipe 246 are fixed to the main engagement portions 2211a and 2211b in a state in which the main guide bar 230ab is inserted through the hole of the field part-fixing pipe 246. In a state in which the linear drive device 200 is assembled, the field part-fixing pipe 246 is arranged substantially coaxially with the main guide bar 230ab such that a fixed spacing is formed between the inner peripheral surface of the field part-fixing pipe 246 and the outer peripheral surface of the main guide bar 230ab. Thus, the field part-fixing pipe 246, the field part FM, and the coil part CP are arranged from the central axis of the main guide bar 230ab toward the outer diameter side in the mentioned order.

The permanent magnets 242a to 242c and the yokes 243a and 243b are alternately arranged in the linear driving direction such that the polarity of the interlinkage magnetic flux acting on the coils 241a and 241b periodically changes within a fixed stroke range in the linear driving direction. Further, to make it possible to obtain the thrust at a stable efficiency at a desired position within the stroke range, the two coils 241a and 241b as an example of the plurality of coils are arranged side by side in the linear driving direction, and energization to the coils 241a and 241b is controlled according to a stroke position. This multi-magnetic pole type arrangement has an advantage that the influence of magnetic saturation is difficult to be received and it is possible to extend the stroke range by forming a periodic structure.

The filling member 244 and the cushioning member 245 are members for positioning the field part FM to the lens holder 221 and at the same time preventing the field part FM from being loosened, and are arranged on opposite sides or on one side of the field part FM in the linear driving direction. The filling member 244 and the cushioning member 245 each have a hollow cylindrical shape having substantially the same inner diameter and the outer diameter as the permanent magnets 242a to 242c and the yokes 243a and 243b. For the cushioning member 245, a material having elasticity, such as sponge or rubber, is used. The cushioning member 245 presses (urges) the filling member 244 in the linear driving direction, whereby it is possible to increase the accuracy of positioning the field part FM in the linear driving direction with respect to the lens assembly 220, and at the same time the field part FM is prevented from being loosened in the linear driving direction.

The field part-fixing pipe 246 is a member for holding the field part FM, the filling member 244, and the cushioning member 245 and at the same time preventing positional displacement of the field part FM in a direction orthogonal to the linear driving direction, which is caused by repulsion of magnetic forces of the permanent magnets 242a to 242c which are arranged such that the same poles are opposed to each other. The field part-fixing pipe 246 can be manufactured by performing a variety of processing methods, such as welding a rolled plate material, cutting from a bar material, extrusion, and drawing, using a material which is thin (small in thickness) and nonmagnetic and has high mechanical strength, such as a copper alloy or an aluminum alloy. By making the outer diameter of the field part-fixing pipe 246 substantially equal to the inner diameter of the field part FM, it is possible to prevent displacement of the field part FM in the direction orthogonal to the linear driving direction.

The field part-fixing pipe 246 is desirable to be small in diameter as much as possible and at the same time thin in thickness so as to suppress reduction of the volume of the permanent magnets 242a to 242c due to insertion of the main guide bar 230ab and the field part-fixing pipe 246. This is because, if the volume of the permanent magnets 242a to 242c is reduced, the interlinkage magnetic flux acting on the coil part CP is reduced, causing lowering of the output power of the linear actuator 240.

The whole length of the field part-fixing pipe 246 is longer than the total length of the field part FM, the filling member 244, and the cushioning member 245, and portions alone (hereinafter referred to as the “protruding portions”) of the field part-fixing pipe 246, on the opposite ends of the field part-fixing pipe 246, are fixed to the lens holder 221. By providing the protruding portions on the field part-fixing pipe 246, it is possible to fix the field part-fixing pipe 246 to the lens holder 221 in a state in which the field part FM, the filling member 244, and the cushioning member 245 are arranged on the field part-fixing pipe 246.

Portions of the lens holder 221, where the main engagement portions 2211a and 2211b extending in the linear driving direction, are formed, form part for accommodating the linear actuator 240 (hereinafter referred to as the “actuator accommodating part”). Next, the configuration of the actuator accommodating part will be described in detail.

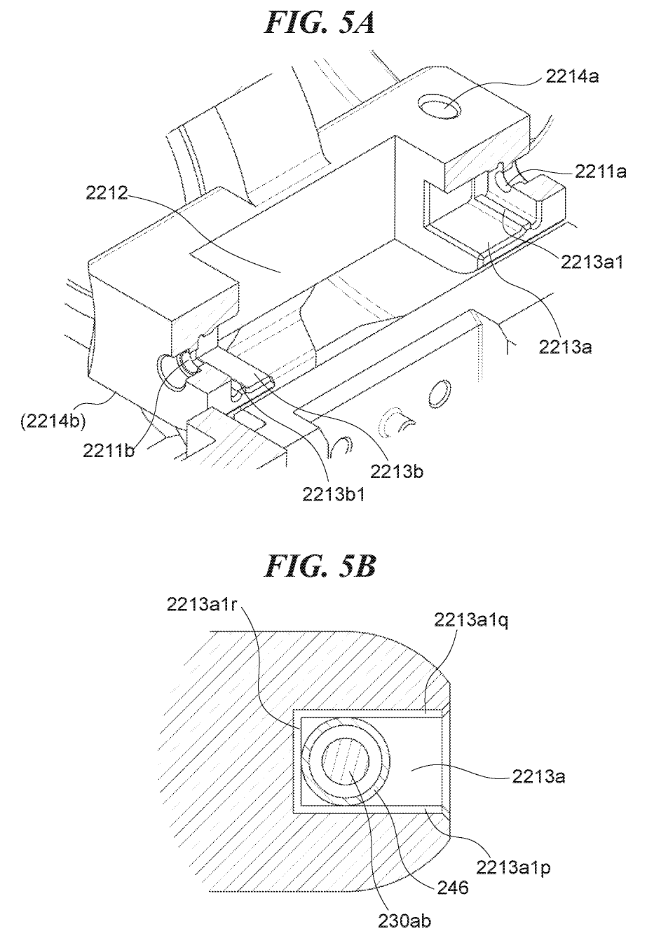

FIG. 5A is a perspective view of the actuator accommodating part of the lens holder 221, part of which is illustrated in cross sections cut along two planes passing the central axis of the main guide bar 230ab (not shown), similar to FIGS. 4A and 4B. The actuator accommodating part includes a space formed between the main engagement portions 2211a and 2211b (hereinafter referred to as the “main opening 2212”). Further, the main engagement portions 2211a and 2211b are provided with sub openings 2213a and 2213b, respectively, which are formed to communicate with (be adjacent to) opposite ends of the main opening 2212 in the optical axis direction.

FIG. 5B is a cross-sectional view of the sub opening 2213a, which is cut along a plane perpendicular to the linear driving direction. The sub openings 2213a and 2213b open toward the side opening 210a1 in a state in which the lens assembly 220 is accommodated in the rear base member 210a.

The sub openings 2213a and 2213b are provided with pipe fixing portions 2213a1 and 2213b1 for positioning and fixing the protruding portions of the field part-fixing pipe 246, respectively. Further, the sub openings 2213a and 2213b are formed with temporary fixing holes 2214a and 2214b, respectively. Similar to the temporary fixing holes 210a2a and 210a2b, the temporary fixing holes 2214a and 2214b are inserted portions into which the temporary fixing pins 261a and 261b are inserted, respectively, when the linear drive device 200 is assembled. Note that the temporary fixing hole 2214b is formed in the main engagement portion 2211b on an opposite surface from the surface formed with the temporary fixing hole 2214a, and hence is invisible in FIG. 5A.

The main opening 2212 and the sub openings 2213a and 2213b open in a direction (radial direction) substantially orthogonal to the linear driving direction. When the linear drive device 200 is assembled, the linear actuator 240 is inserted into the main opening 2212 and the sub openings 2213a and 2213b from the radial direction. The main opening 2212 has a width which can prevent interference with the coil part CP in the movable range of the lens assembly 220 as the stroke range of the linear actuator 240.

The field part FM is positioned in the linear driving direction by pressing the cushioning member 245 against the side wall as an end of the main opening 2212 in the linear driving direction. Further, the field part FM is positioned and held in the radial direction by pressing the protruding portions of the field part-fixing pipe 246 into the pipe fixing portions 2213a1 and 2213b1 of the sub openings 2213a and 2213b, respectively.

As shown in FIG. 5B, the pipe fixing portion 2213a1 is formed by pipe-positioning seat surfaces 2213a1p, 2213a1q, and 2213a1r. The protruding portion of the field part-fixing pipe 246 is positioned in a direction orthogonal to the opening direction of the sub opening 2213a by the two surfaces of the pipe-positioning seat surfaces 2213a1p and 2213a1q. Further, the protruding portion of the field part-fixing pipe 246 is brought into abutment with the pipe-positioning seat surface 2213a1r, thereby being positioned in the opening direction of the sub opening 2213a. The sub opening 2213b is also formed with the pipe fixing portion 2213b1 formed similarly to the pipe fixing portion 2213a1 of the sub opening 2213a. By thus positioning the field part-fixing pipe 246 with respect to the lens holder 221 without looseness, the field part FM is also positioned with high accuracy.

Further, the sub openings 2213a and 2213b have not only the role of positioning the field part FM in the lens holder 221 by narrowing the main opening 2212, but also the role of storage space for storing an adhesive used to fix the protruding portions of the field part-fixing pipe 246. Although details will be described hereinafter, by pouring the adhesive into the sub openings 2213a and 2213b from the radial direction, it is possible to fix the field part-fixing pipe 246 and the lens holder 221.

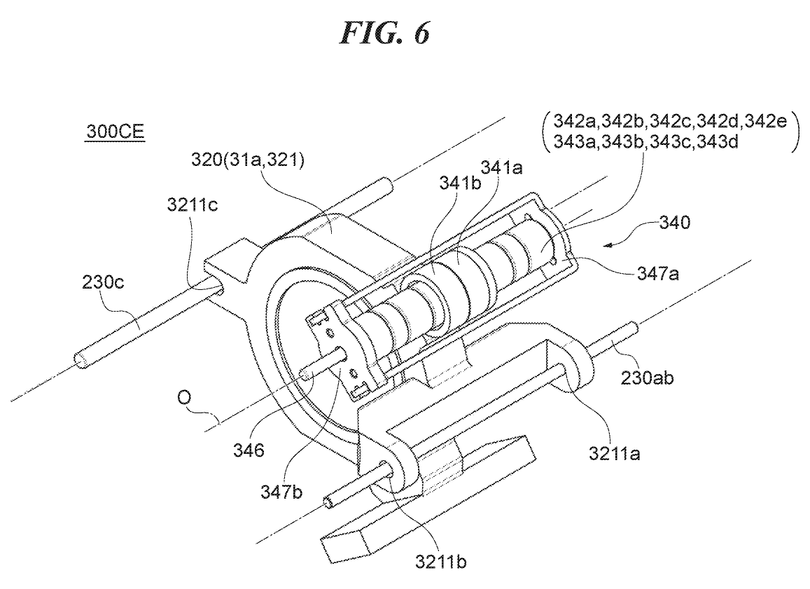

Next, the characteristics of the linear drive device 200 will be described in comparison with a comparative example to which the conventional technique is applied. FIG. 6 is a perspective view showing a configuration of essential parts of a linear drive device 300CE according to the comparative example and corresponds to FIG. 3. Note that the same components (parts) of the linear drive device 300CE as the components of the linear drive device 200 according to the first embodiment are denoted by the same reference numerals. Further, ones of the components of the linear drive device 300CE, which are equivalent to those of the linear drive device 200 according to the first embodiment, are denoted by changing a value of the top of each reference numeral from “2” to “3”. The following description will be given mainly of different points of the linear drive device 300CE from the linear drive device 200, and description of the same points is omitted.

The linear drive device 300CE largely differs from the linear drive device 200 in that a linear actuator 340 does not overlap the main guide bar 230ab on an optical axis projection plane. Therefore, in the linear drive device 300CE, the thrust application point (the central axis of the coil part CP) and the main guide axis (the central axis of the main guide bar 230ab) do not overlap each other on the optical axis projection plane.

In the linear drive device 300CE, main engagement portions 3211a and 3211b of a lens holder 321 are slidably engaged with the main guide bar 230ab, and a sub engagement portion 3211c of the lens holder 321 is engaged with the sub guide bar 230c. The linear actuator 340 has coils 341a and 341b, which form the coil part CP, and permanent magnets 342a, 342b, 342c, 342d, and 342e, and yokes 343a, 343b, 343c, and 343d, which form the field part FM. Further, the linear actuator 340 has a field part-fixing shaft 346 and external yokes 347a and 347b.

Inner peripheral surfaces of the coils 341a and 341b are fixed to the lens holder 321 e.g. by bonding such that a fixed spacing is held between the inner peripheral surfaces of the coils 341a and 341b and the outer peripheral surfaces of the permanent magnets 342a to 342e and the yokes 343a to 343d, and at the same time the central axis thereof is substantially parallel to the optical axis of a focus lens 31a. The coils 341a and 341b are arranged so as not to overlap the components associated with movement of a lens assembly 320 in the optical axis direction, such as the focus lens 31a, the main guide bar 230ab, and the sub guide bar 230c, on the optical axis projection plane.

] The permanent magnets 342a to 342e and the yokes 343a to 343d, each having a hollow cylindrical shape, are different in component number from those of the linear actuator 240, but are alternately arranged in the linear driving direction such that the same poles of the permanent magnets 342a to 342e are opposed to each other in the linear driving direction to form the field part FM. The permanent magnets 342a to 342e and the yokes 343a to 343d are fixed to the field part-fixing shaft 346 by inserting the field part-fixing shaft 346 having substantially the same outer diameter as the inner diameters of the permanent magnets 342a to 342e and the yokes 343a to 343d through holes of the permanent magnets 342a to 342e and the yokes 343a to 343d. Note that the field part FM of the linear actuator 340 is positioned in the optical axis direction, by a filling member and a cushioning member, separately, but these components are omitted from illustration in FIG. 6.

The external yokes 347a and 347b are used to fix the linear actuator 340 to a base member, such as the rear base member 210a (not appearing in FIG. 6), but are not required depending on a method of assembling the linear actuator 340 to the base member.

In the linear drive device 300CE, the linear actuator 340 does not overlap the main guide bar 230ab on the optical axis projection plane. For this reason, the center of the coil part CP as the thrust application point of the linear actuator 340 and the central axis of the main guide bar 230ab are separated on the optical axis projection plane, which causes an increase in the guide resistance. In contrast, in the linear drive device 200 according to the first embodiment, the thrust application point substantially coincides with the main guide bar 230ab on the optical axis projection plane, and hence it is possible to reduce the guide resistance to the minimum, and the reason for this will be described hereinafter.

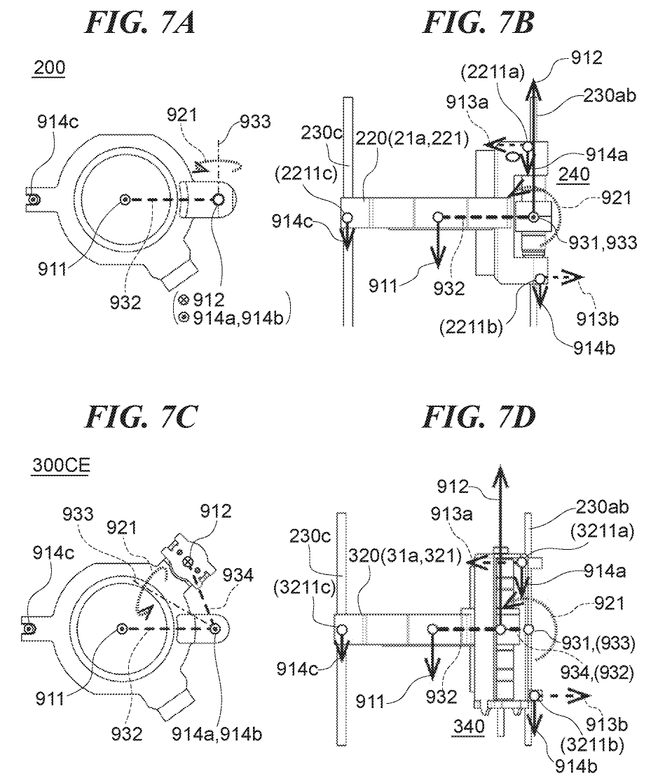

FIGS. 7A and 7B are views useful in explaining forces acting on the lens assembly 220 when driving the linear drive device 200. FIG. 7A is a front view, and FIG. 7B is a top view. FIGS. 7C and 7D are views useful in explaining forces acting on the lens assembly 320 when driving the linear drive device 300CE. FIG. 7C is a front view, and FIG. 7D is a top view. In FIGS. 7A to 7D, the forces acting on the lens assembly 220/320 when driving the lens assembly 220/320 upward in a vertical direction against the gravity (hereinafter referred to as the “gravity climbing direction”) are illustrated. The gravity climbing direction is a direction toward the far side of the drawings in FIGS. 7A and 7C, and a direction toward the top of the drawings in FIGS. 7B and 7D.

In the lens assemblies 220 and 320, a force applied downward in the vertical direction (hereinafter referred to as the “gravity 911” for convenience), as the sum of the gravity and the inertia force, acts on the respective centers of gravity, and a thrust 912 acts on the respective coil parts CP. Further, normal forces 913a and 913b and guide resistances 914a and 914b act on the main engagement portions 2211a and 2211b and the main engagement portions 3211a and 3211b, respectively, and a guide resistance 914c acts on the sub engagement portions 2211c and 3211c. A rotational moment 921 also acts on the lens assembly 220.

In the following description, center points in the linear driving direction between the main engagement portions 2211a and 2211b and between the main engagement portions 3211a and 3211b, which mainly regulate rotation of the lens assemblies 220 and 320, respectively, are defined as the “virtual supporting point 931”. Further, a straight line connecting between the virtual supporting point 931 and the center of gravity of the lens assembly 220/320 is defined as the “gravity center transverse line 932”, and a plane including the two straight lines of the central axis of the main guide bar 230ab and the gravity center transverse line 932 is defined as the “gravity center transverse plane”. Further, a straight line which passes the virtual supporting point 931 and forms the rotational axis of the rotational moment 921 is defined as the “lens rotational axis 933”.

In the lens assembly 220/320, the gravity 911 acting on the lens assembly 220/320 generates the rotational moment 921 about the lens rotational axis 933 as the rotational axis. The linear actuator 240/340 cannot be arranged on the center of gravity of the lens assembly 220/320, and hence generation of the rotational moment 921 cannot be avoided. Therefore, the rotational moment 921 can be said as the moment which is inevitable in the linear drive device 200.

In the configuration in which the thrust 912 does not overlap the lens assembly 220 on the optical axis projection plane, the thrust 912 can also be a cause of increasing the rotational moment 921. However, in the linear drive device 200 according to the first embodiment, the thrust 912 overlaps the virtual supporting point 931 on the optical axis projection plane, and hence the thrust 912 does not affect the rotational moment 921, and hence, it is possible to reduce the rotational moment 921.

Sliding portions (contact portions) between the main guide bar 230ab and the main engagement portions 2211a and 2211b, which are caused by the rotational moment 921 on a side of the main engagement portion 2211a, toward the photographing optical axis, and on a side of the main engagement portion 2211b, opposite from the photographing optical axis, respectively, are defined as the “main guide sliding surfaces”. Further, a sliding surface between the sub guide bar 230c and the sub engagement portion 2211c is defined as the “sub guide sliding surface”.

On the main guide sliding surfaces, the normal forces 913a and 913b are generated in a direction substantially parallel to the linear guide transverse line. The normal forces 913a and 913b generate frictional forces on the main guide sliding surfaces, which act in a direction opposite from the moving direction of the lens assembly 220. Further, in general, a lubricating material is applied to the main guide bar 230ab to reduce sliding load, and viscous forces acting in the moving direction is generated by the lubricating material and the above-mentioned frictional forces. These frictional force and viscous force form main components of the guide resistances 914a and 914b. Similarly, although the guide resistance 914c is generated on the sub guide sliding surface as well, the guide resistance 914c is not a force generated due to the rotational moment 921 generated by the gravity 911. Therefore, compared with the guide resistances 914a and 914b acting on the main guide sliding surface, the guide resistance 914c is small, and an influence of the guide resistance 914c on all guide resistances is small.

For this reason, the linear drive device having the configuration including only one linear actuator (hereinafter referred to as the “single actuator configuration”) has a problem that the guide resistance is large. In the linear drive device 200 according to the first embodiment, this problem is solved by arranging the linear actuator 240 such that the thrust application point overlaps the main guide bar 230ab (virtual supporting point 931) on the optical axis projection plane. That is, in the linear drive device 200, the configuration which enables reduction of the rotational moment 921 makes it possible to reduce the guide resistances 914a and 914b.

Further, the linear actuator 240 is formed by the necessary minimum number of components including the coil part CP and the field part FM, which are the main components of the electromagnetic type linear DC motor. Therefore, by configuring the linear drive device 200 such that it has the single linear actuator 240, it is possible to achieve compactness and lightweight while ensuring the necessary driving performance, and further, it is possible to achieve low costs by reducing the number of components.

In contrast, in the linear drive device 300CE according to the comparative example, as shown in FIG. 7C, the thrust 912 is generated at a location remote from the virtual supporting point 931 by a distance corresponding to a linear guide transvers line 934, on the optical axis projection plane. That is, the thrust generation position (thrust application point) of the thrust 912 of the linear actuator 340 and the virtual supporting point 931 do not substantially coincide with each other, on the optical axis projection plane. Therefore, not only the gravity 911, but also the thrust 912 affects the rotational moment 921 generated on the lens assembly 320, which increases the rotational moment 921, and as a result, the guide resistances 914a and 914b are increased.

Further, in the linear drive device 300CE according to the comparative example, the linear actuator 340 is required to be arranged at a location where the linear actuator 340 does not overlap the main guide bar 230ab on the optical axis projection plane, and hence a space occupied by the linear drive device 300CE in the product (lens barrel 20) is increased. In contrast, in the linear drive device 200 according to the first embodiment, the linear actuator 240 partially overlaps the main guide bar 230ab as a component of the linear guide mechanism, on the optical axis projection plane, and hence the space occupied by the linear drive device 200 as a whole is small. Therefore, according to the linear drive device 200, compared with the linear drive device 300CE, the occupied space is small, and hence an advantageous effect that it is possible to reduce the size of the product can be obtained.

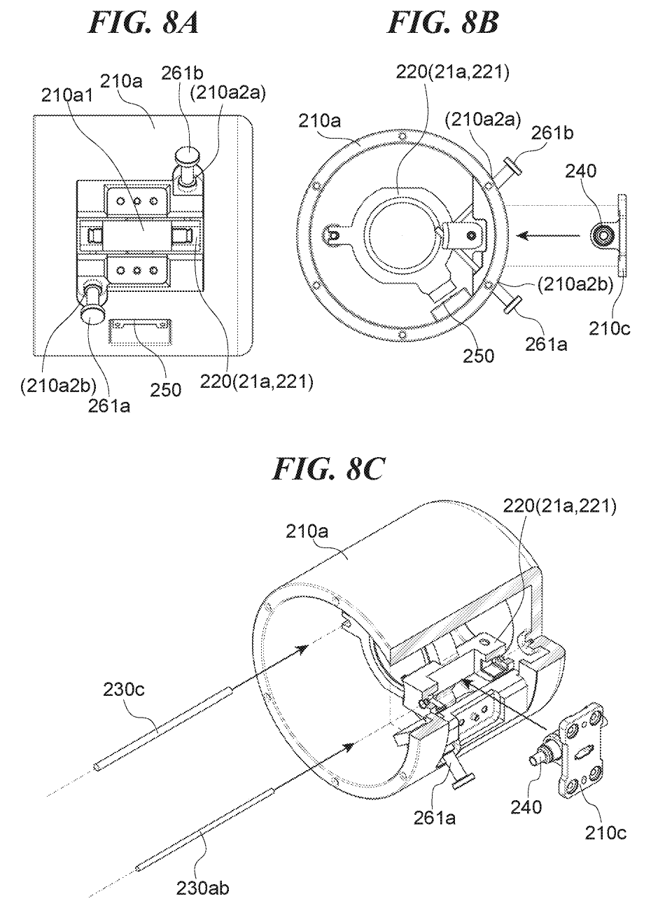

Next, steps (manufacturing method) for assembling the linear drive device 200 according to the first embodiment will be described. FIGS. 8A to 8C are views useful in explaining the steps for assembling the linear drive device 200, and the description given with reference to FIGS. 8A to 8C will be made, by referring to FIG. 2, referred to hereinabove, as required.

First, three components of the component group forming the linear drive device 200 are each assembled. As the first component, the lens assembly 220 is assembled by fixing the focus lens 21a to the lens holder 221. As the second component, a “coil adhered base” is assembled by fixing the coils 241a and 241b to the side base member 210c e.g. by UV adhesion. As the third component, parts of the linear actuator 240 other than the coil part CP are assembled (hereinafter, the resulting assembly is referred to as the “field part temporarily assembled part”).

Then, the lens assembly 220 is received in the rear base member 210a. Then, the temporary fixing pins 261a and 261b are inserted into the temporary fixing holes 2214a and 2214b, formed in the lens holder 221, through the temporary fixing holes 210a2a and 210a2b, formed in the rear base member 210a, from the radial direction of the rear base member 210a, respectively. With this, the lens assembly 220 is temporarily fixed in a predetermined position with respect to the rear base member 210a. FIG. 8A shows a state in which the lens assembly 220 has been received in the rear base member 210a, and the temporary fixing pins 261a and 261b have been inserted, as viewed from the radial direction of the rear base member 210a. As shown in FIG. 8A, when the lens assembly 220 has been received in the rear base member 210a, the actuator accommodating part of the lens holder 221 can be viewed from the radial direction of the rear base member 210a through the side opening 210a1. That is, the actuator accommodating part of the lens holder 221 communicates with the side opening 210a1.

At this time, by inserting the two temporary fixing pins 261a and 261b into the temporary fixing holes 2214a and 2214b in a state in which a predetermined angle is formed by the temporary fixing pins 261a and 261b, it is possible to realize restriction of six degrees of freedom. The angle formed by the temporary fixing pins 261a and 261b is desirable to be an ideal value of approximately 90° (or a value close to 90°) in the linear drive device 200 but is not limited to this, depending on a component shape and the arrangement with the other components, insofar as it is not equal to 0°. The number of the temporary fixing pins 261a and 261b is not limited to two but is only required to be two or more.

Thus, by providing a step for temporarily fixing the lens assembly 220 to the predetermined position with respect to the rear base member 210a, it is possible to easily perform operations in assembly steps thereafter. Specifically, the field part temporarily assembled part and the coil adhered base are in a relationship in which they overlap the side opening 210a1 on a plane projected from the radial direction of the rear base member 210a. Therefore, as shown in FIG. 8B, the coil adhered base and the field part temporarily assembled part are inserted from the radial direction through the side opening 210a1 in a state overlapping each other (a state in which the field part FM has been inserted in the hole of the coil part CP). Thus, the coil part CP of the coil adhered base and the field part temporarily assembled part are accommodated in the main opening 2212 and the sub openings 2213a and 2213b of the actuator accommodating part inside the rear base member 210a.

At this time, by pressing the protruding portions of the field part-fixing pipe 246 into the pipe fixing portions 2213a1 and 2213b1, respectively, the field part temporarily assembled part is positioned on the lens holder 221. Further, when the side base member 210c is fixed to the rear base member 210a e.g. with screws, the coil part CP is positioned by the positioning mechanism of the side base member 210c and the rear base member 210a.

With the assembling steps described so far, the coil part CP and the field part FM are arranged substantially coaxially with the main guide bar 230ab on the optical axis projection plane. And, fixed spacings are formed between the inner peripheral surface of the coil part CP and the outer peripheral surface of the field part FM, and between the outer peripheral surface of the main guide bar 230ab and the inner peripheral surface of the field part-fixing pipe 246, respectively.

Next, the field part temporarily assembled part is fixed to the lens holder 221 e.g. by UV adhesion. With the steps described so far, at least part of the protruding portions of the field part-fixing pipe 246 (at least part of the sub openings 2213a and 2213b) overlaps the side opening 210a1 on a plane projected from the radial direction. Then, in the present step, a needle or the like for injecting an adhesive is inserted from the side opening 210a1 in the radial direction, and the protruding portions of the field part-fixing pipe 246 are fixed to the lens holder 221 by injecting the adhesive into the sub openings 2213a and 2213b.

Then, the main guide bar 230ab and the sub guide bar 230c are inserted in the main engagement portions 2211a and 2211b and the sub engagement portion 2211c of the lens holder 221 from the linear driving direction, respectively, and front end portions of these are fixed to the rear base portion 210a. Note that the main guide bar 230ab and the sub guide bar 230c are pressed in and fixed to the press-fixing portions provided in the rear base member 210a. The two steps, i.e. the step illustrated in FIG. 8B and the step for inserting the main guide bar 230ab and the sub guide bar 230c are schematically illustrated in FIG. 8C, and in FIG. 8C, part of the components are illustrated in cross section to increase the visibility.

[00 85 ] Finally, the front base member 210b is fixed to the rear base member 210a e.g. with screws. At this time, non-fixed ends of the main guide bar 230ab and the sub guide bar 230c are pressed in and fixed to press-fixing portions formed in the front base member 210b. Then, by fixing the linear encoder 250 to the rear base member 210a, and drawing out the temporary fixing pins 261a and 261b, the assembly of the linear drive device 200 is completed.

Thus, the linear drive device 200 according to the first embodiment can be easily assembled by providing the side opening 210a1 formed in the rear base member 210a and assembling therein from the radial direction.

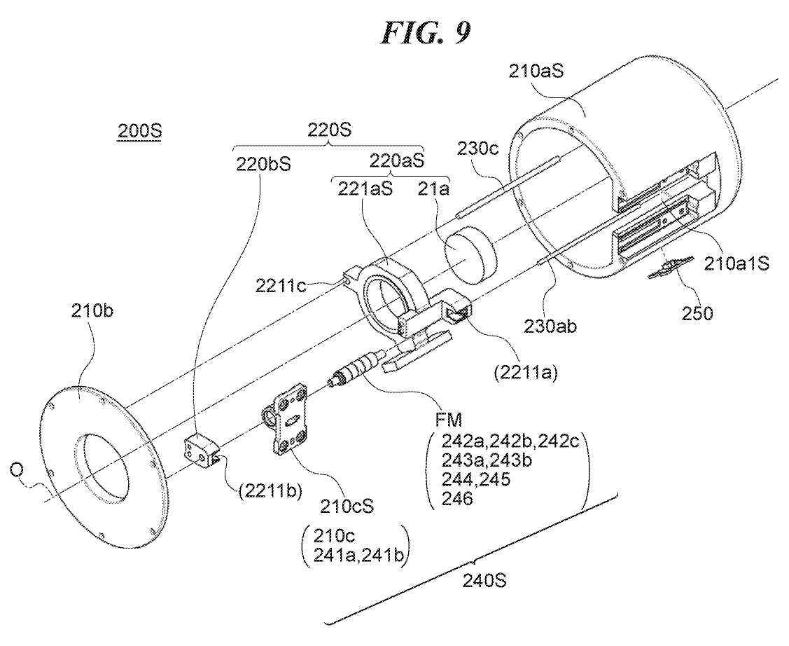

Next, a linear drive device 200S according to a second embodiment, which realizes the assembling steps without using the temporary fixing pins 261a and 261b, will be described. FIG. 9 is an exploded perspective view of the linear drive device 200S. The linear drive device 200S has a structure which makes it possible to assemble the linear drive device 200S only in the one direction of the linear driving direction, as described hereinafter.

Note that components of the linear drive device 200S, which are the same as those of the linear drive device 200 are denoted by the same reference numerals. Further, components of the linear drive device 200S, which are equivalent to the exploded ones of each corresponding component of the linear drive device 200, are denoted by the same reference numerals, to the end of which “a” or “b” is added.

As a first different point of the linear drive device 200S from the linear drive device 200, a side opening 210a1S is cut open in a front end face (side toward the front base member 210b) of the rear base member 210aS. Further, as a second different point, the lens holder 221 used in the linear drive device 200 is changed into the two components of a lens holder 221aS and a separate engagement component 220bS. More specifically, the focus lens 21a and the lens holder 221aS forms a pre-lens assembly 220aS, referred to hereinafter, and the pre-lens assembly 220aS and the separate engagement component 220bS form the linear drive device 200S. The lens holder 221aS has the main engagement portion 2211a, and the separate engagement component 221bS has the main engagement portion 2211b. With this configuration, it is possible to insert the components of a linear actuator 240S from the linear driving direction (from the side toward the front base member 210b) and thereby arrange the linear actuator 240S between the main engagement portions 2211a and 2211b.

The steps for assembling the linear drive device 200S are roughly as follows: First, similar to the steps for assembling the linear drive device 200, the first to third components are assembled. As the first component, the pre-lens assembly 220aS is assembled by fixing the lens holder 221aS and the focus lens 21a. As the second component, a coil adhered base 210cS is assembled by fixing the coils 241a and 241b to the side base member 210c e.g. by UV adhesion. As the third component, a field part temporarily assembled part as part of the linear actuator 240S, other than the coil part CP, is assembled.

Then, respective one ends of the main guide bar 230ab and the sub guide bar 230c are pressed in and fixed to the press-fixing portions provided in the rear base member 210aS. The main engagement portion 2211a and the sub engagement portion 2211c of the lens holder 221aS are fitted on the main guide bar 230ab and the sub guide bar 230c, respectively, and the pre-lens assembly 220aS is slid into the rear base member 210aS and disposed therein.

Then, the coil adhered base 210cS and the field part temporarily assembled part are assembled with the main guide bar 23ab by inserting them from the side toward the front base member 210b in the linear driving direction. At this time, an end portion of one of the protruding portions of the field part-fixing pipe 246 is pressed into the pipe fixing portion 2213a1 of the sub opening 2213a. Note that any of the coil adhered base 210cS and the field part temporarily assembled part can be inserted first. Further, the coil adhered base 210cS can be inserted by sliding the coil adhered base 210cS into the side opening 210a1S of the rear base member 210aS in the linear driving direction.

After that, the separate engagement component 221bS is fixed to the lens holder 221aS by inserting the main guide bar 230ab through the main engagement portion 2211b and sliding the same toward the pre-lens assembly 220aS. At this time, an end portion of the other protruding portion of the field part-fixing pipe 246 is pressed into the pipe fixing portion 2213b1 of the sub opening 2213b, formed in the separate engagement component 221bS. Note that, to fix the separate engagement component 221bS to the lens holder 221aS, a method, such as a method of pressing a boss formed on the lens holder 221aS into a boss hole formed in the separate engagement component 221bS, can be used. Thus, the linear actuator 240S is arranged between the main engagement portions 2211a and 2211b.

Finally, similar to the steps for assembling the linear drive device 200, the side base member 210c is fixed to the rear base member 210a e.g. with screws, and the protruding portions of the field part-fixing pipe 246 are fixed to the lens holder 221 with an adhesive. Then, the front base member 210b is fixed to the rear base member 210a e.g. with screws such that the non-fixed ends of the main guide bar 230ab and the sub guide bar 230c are pressed in and fixed to the press-fixing portions formed in the front base member 210b. Thus, the assembly of the linear drive device 200S is completed.

As described above, according to the embodiments of the present disclosure, it is possible to provide the linear drive device 200/200S that is small in guide resistance, compact, lightweight, and easy to assemble.

For example, although in the above-described embodiments, the description has been given of the configuration using the multi-magnetic pole type linear actuator for the linear drive device, the effect associated with arrangement of the linear actuator can also be obtained by using a single magnetic pole type linear actuator. Further, the linear drive device according to the present embodiments can be applied not only to the lens assembly as the driven body, but can be applied to a variety of devices required to linearly move a driven body.

According to the present disclosure, it is possible to provide the linear drive device that is low in guide resistance and prevents the product from being increased in size and weight.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-080414, filed May 13, 2025, which is hereby incorporated by reference herein in its entirety.

What is claimed is:

1. A linear drive device comprising:
a fixed barrel having a side opening;
a cover member that is attached to the fixed barrel in the side opening;
a driven body that has an object to be driven and is accommodated inside the fixed barrel;
a linear actuator that is arranged inside the fixed barrel and drives the driven body in a first direction; and
a linear guide that includes a main guide bar and a sub guide bar for supporting the driven body in a state movable in the first direction inside the fixed barrel,
wherein the linear actuator includes:
a field part having hollow-shaped permanent magnets;
a coil part that is fixed to the cover member and is formed by hollow-shaped coils arranged to surround an outer periphery of the field part; and
a pipe-shaped holding member that is inserted in a hole of the field part to hold the field part and is fixed to the driven body,
wherein the main guide bar is inserted through a hole of the pipe-shaped holding member, and
wherein fixing portions for fixing the pipe-shaped holding member are formed in an opening which opens toward the side opening.

2. The linear drive device according to claim 1, wherein the main guide bar, the pipe-shaped holding member, the field part, and the coil part are arranged substantially coaxially with each other, and
wherein fixed spacings are formed between an outer peripheral surface of the main guide bar and an inner peripheral surface of the pipe-shaped holding member, and between an outer peripheral surface of the field part and an inner peripheral surface of the coil part, respectively.

3. The linear drive device according to claim 1, wherein a length of the pipe-shaped holding member is longer than a length of the field part in the first direction, and opposite ends of the pipe-shaped holding member form protruding portions which do not hold the field part, and
wherein at least part of the protruding portions overlaps the side opening on a plane projected from a radial direction of the fixed barrel.

4. The linear drive device according to claim 3, wherein the driven body has two engagement portions formed with a predetermined distance therebetween in the first direction, and at the same time, the two engagement portions are each formed with the opening having the fixing portion,
wherein the field part and the coil part are arranged in a space formed between the two engagement portions, and
wherein the protruding portions are pressed into the fixing portions and at the same time fixed by an adhesive.

5. The linear drive device according to claim 4, wherein the two engagement portions are integrally formed with the driven body.

6. The linear drive device according to claim 4, wherein inserted portions for inserting a jig for temporarily fixing the driven body to the fixed barrel in a state in which the driven body has been inserted into the fixed barrel are formed in the fixed barrel and the driven body, respectively.

7. The linear drive device according to claim 4, wherein the side opening is not cut open in an end face of the fixed barrel.

8. The linear drive device according to claim 4, wherein the side opening is cut open up to one end of the fixed barrel, and
wherein one of the two engagement portions is integrally formed with the driven body, and the other is a separate component and is fixed to the driven body.

9. The linear drive device according to claim 8, further including a cover member that holds the coil part and is attached to the side opening, and
wherein the cover member is inserted into the side opening from the one end of the side opening, which is cut open, along the first direction, and is fixed to the fixed barrel at a predetermined location in the first direction.

10. The linear drive device according to claim 4, wherein a filling member and a cushioning member for positioning the field part between the two engagement portions in the first direction are held by the pipe-shaped holding member.

11. A lens barrel comprising:
a linear drive device as claimed in claim 1, and
wherein the driven body is a lens assembly in which a focus lens or a zoom lens is fixed to a lens holder.

12. An image capturing system comprising:
a lens barrel as claimed in claim 11, and
an image capturing apparatus, to which the lens barrel can be removably attached, the image capturing apparatus including an image sensor which converts an optical image formed through the lens barrel to electrical signals.

13. An image capturing apparatus comprising:
a lens barrel as claimed in claim 11, and
an image capturing apparatus body including an image sensor which converts an optical image formed through the lens barrel to electrical signals.

14. A method of manufacturing a linear drive device, comprising:
fixing a hollow cylindrical coil part of a linear actuator to a side base member covering part of a side opening of a hollow cylindrical rear base member;
inserting a pipe-shaped holding member into a hole of a hollow cylindrical field part of the linear actuator to attach the field part to the pipe-shaped holding member;
temporarily fixing a driven body to be driven by the linear actuator inside the rear base member;
inserting the coil part, the field part, and the pipe-shaped holding member into the rear base member through the side opening in a state in which the pipe-shaped holding member holding the field part has been inserted through the coil part, and engaging end portions of the pipe-shaped holding member to main engagement portions formed on the driven body;
fixing the side base member to the rear base member in the side opening;
fixing the end portions of the pipe-shaped holding member to the main engagement portions by injecting an adhesive from a radial direction of the rear base member;
inserting a main guide bar into a hole formed in the pipe-shaped holding member and the main engagement portions, and fixing a front end of the main guide bar to the rear base member;
engaging a sub guide bar with a sub engagement portion formed on the driven body and fixing a front end of the sub guide bar to the rear base member; and
fixing, while fixing non-fixed ends of the main guide bar and the sub guide bar to a front base member, the front base member to the rear base member.

15. A method of manufacturing a linear drive device, comprising:
fixing a hollow cylindrical coil part of a linear actuator to a side base member covering part of a side opening of a hollow cylindrical rear base member, which is cut open up to one end of the rear base member;
inserting a pipe-shaped holding member into a hole of a hollow cylindrical field part of the linear actuator to attach the field part to the pipe-shaped holding member;
fixing respective one ends of a main guide bar and a sub guide bar to the rear base member;
engaging main engagement portions and a sub engagement portion of a driven body to be driven by the linear actuator with the main guide bar and the sub guide bar, respectively, and sliding the main engagement portions and the sub engagement portion into the rear base member;
assembling the pipe-shaped holding member and the coil part with the main guide bar while sliding the side base member to the side opening, and engaging one of end portions of the pipe-shaped holding member with an engagement portion formed on the driven body;
fixing a separate engagement component to be engaged with the main guide bar to the driven body such that the field part is sandwiched between the separate engagement component and the main engagement portion, and at the same time the separate engagement component is engaged with the other of the end portions of the pipe-shaped holding member;
bonding the end portions of the pipe-shaped holding member to the main engagement portion and the separate engagement component by injecting an adhesive from a radial direction of the rear base member;
fixing the side base member to the rear base member in the side opening; and
fixing, while fixing non-fixed ends of the main guide bar and the sub guide bar to a front base member, the front base member to the rear base member.
